(19) United States
(12) Patent Application Publication
(10) Pub. No.: US 2013/0000433 A1
(43) Pub. Date: Jan. 3, 2013

(54) DUAL SLIDING ASSEMBLY

(75) Inventor: CONG LIU, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/349,679

(22) Filed: Jan. 13, 2012

(30) Foreign Application Priority Data
Jun. 30, 2011 (CN) 201110181639.0

(51) Int. Cl. F16H 21/44

(52) U.S. Cl. 74/103

(57) ABSTRACT

A sliding assembly includes a main body, a sliding element, a first elastic device and a second elastic device. The sliding element can slide relative to the main body in a first direction and a second direction. The first elastic device is rotatably fixed to the sliding element, the first elastic device providing a first elastic force driving the sliding element to slide relative to the main body in the first direction and the second direction. The second elastic device provides a second elastic force to lock the sliding element at different states.

### BACKGROUND

1. Technical Field

This disclosure relates to sliding assemblies, particularly to a dual sliding assembly.

2. Description of Related Art

Many mobile phones include a cover with a display mounted thereon, a base with a keypad mounted thereon, and a sliding assembly comprising a retaining plate and a sliding plate slidably mounted to the retaining plate. The cover is mounted to the sliding plate and the base is mounted to the retaining plate, so that the cover can slide relative to the base when the sliding plate moves relative to the retaining plate. However in many product configurations, the sliding assembly only can be moved in one direction, it can not satisfy various usage conditions.

Therefore, there is a room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary sliding assembly. Moreover, in the drawings, like reference numerals designate corresponding parts throughout the several views. Wherever possible, the same reference numbers are used throughout the drawings to refer to the same or like elements of an embodiment.

FIG. 1 is an exploded view of a sliding assembly according to an exemplary embodiment.

FIG. 2 is another exploded view of the sliding assembly in FIG. 1.

FIG. 3 is a schematic view of a main body of the sliding assembly in FIG. 1.

FIG. 4 is an assembled view of the sliding assembly in FIG. 1.

FIG. 5 is a perspective view of the sliding assembly of FIG. 4 in a first state.

FIG. 6 is similar to FIG. 4, but showing the sliding assembly in a second state in which a sliding element slides relative the main body in a first direction.

FIG. 7 is similar to FIG. 4, but showing the sliding assembly in a third state in which the sliding element slides relative the main body in a second direction.

### DETAILED DESCRIPTION

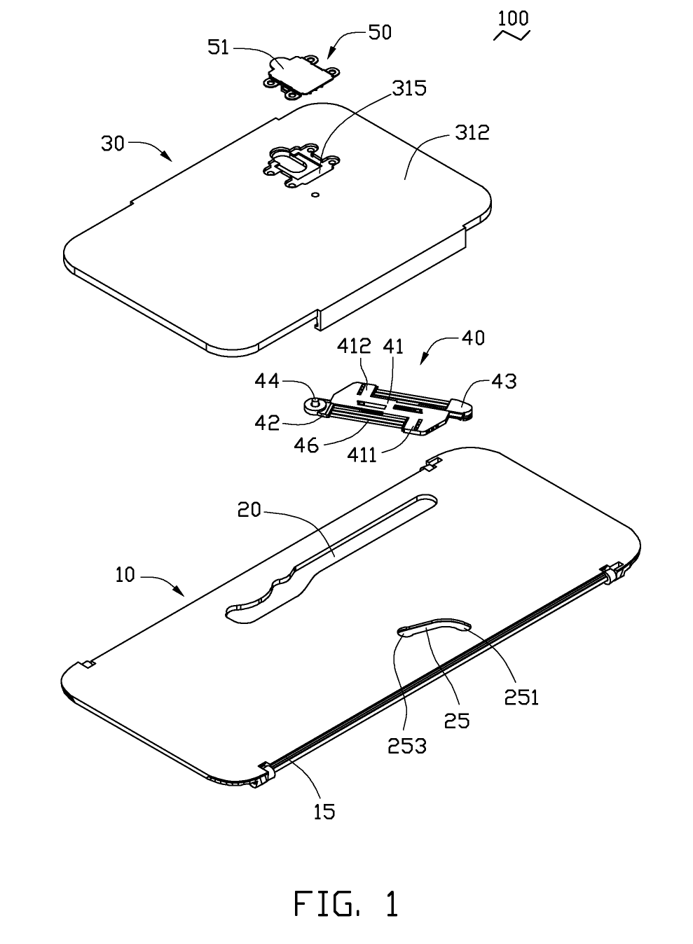

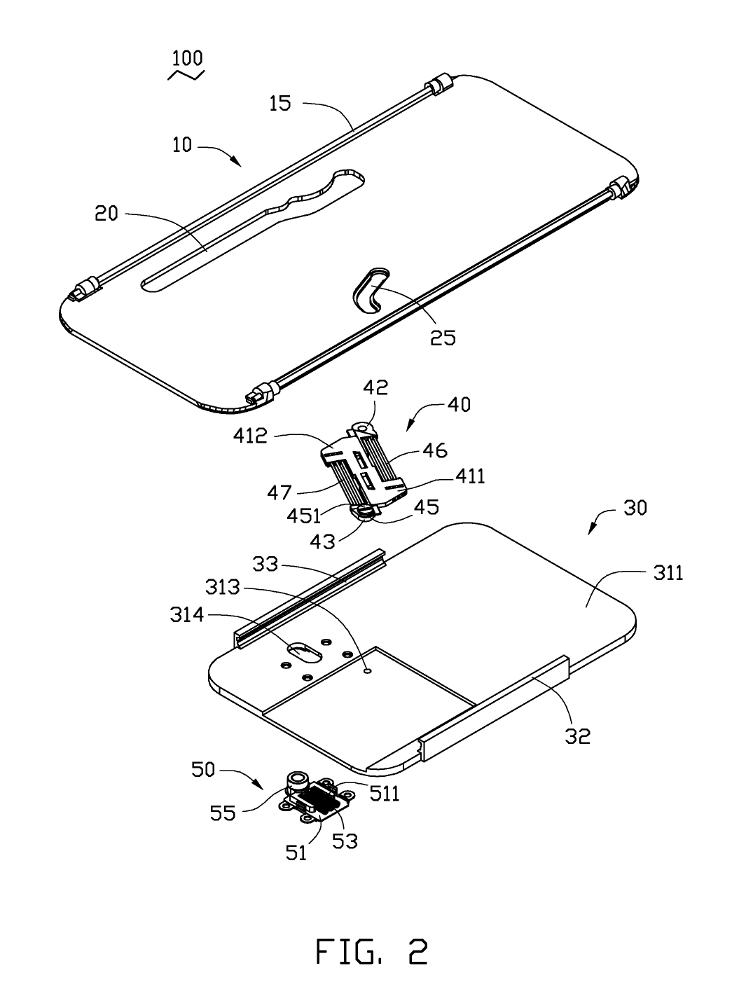

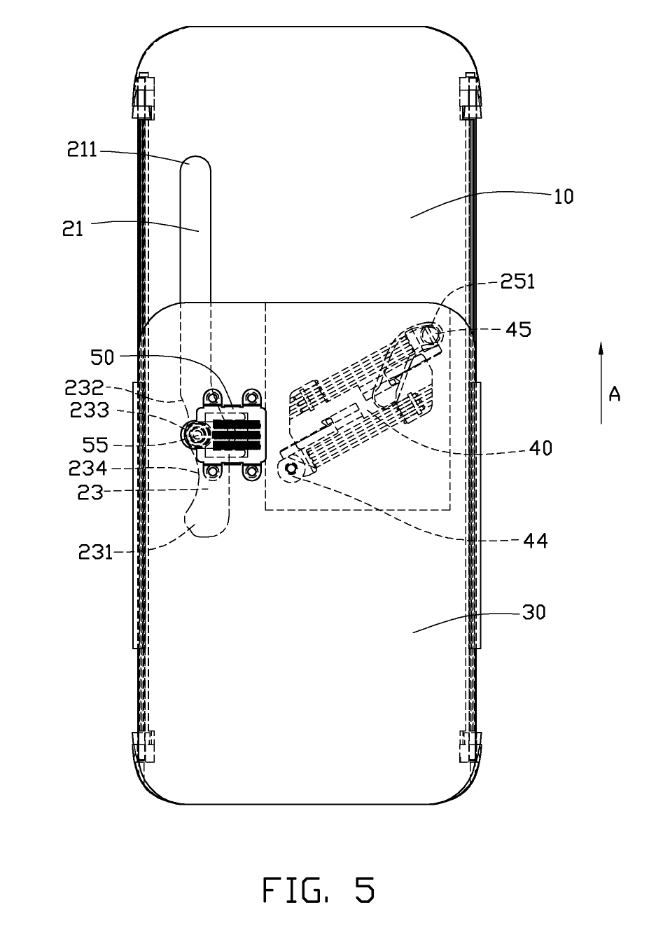

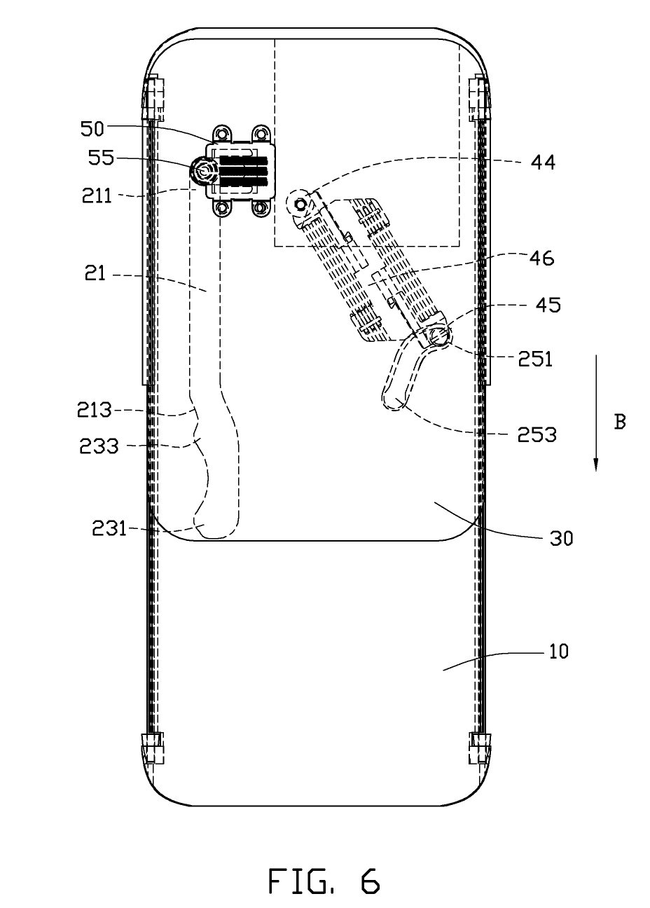

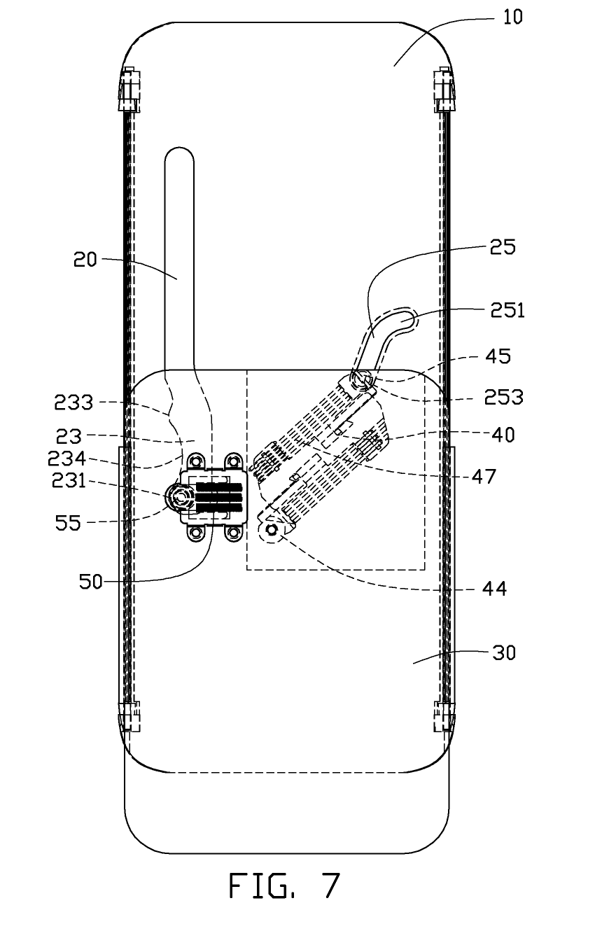

Referring to FIGS. 1 and 2, an exemplary embodiment of a sliding assembly 100 may be adapted to a mobile phone or personal digital assistant. The sliding assembly 100 includes a main body 10, a sliding element 30, a first elastic device 40 and a second elastic device 50. The sliding element 30 is slidably fixed to the main body 10. The first elastic device 40 provides a first elastic force driving the sliding element 30 to slide relative to the main body 10. The second elastic device 50 provides a second elastic force perpendicular to the sliding direction to lock the sliding element 30 at a first state (e.g., a closed state) as in FIG. 5, a second state (e.g., a first open state) as in FIG. 6 and a third state (e.g., a second open state) as in FIG. 7.

The main body 10 includes a set of rails 15, a first guiding slot 25 and a second guiding slot 20. The rails 15 are located at opposite sides of the main body 10. The first guiding slot 25 is defined through the main body 10 adjacent to one of the rails 15, the second guiding slot 20 is defined through the main body 10 adjacent to the other rail 15.

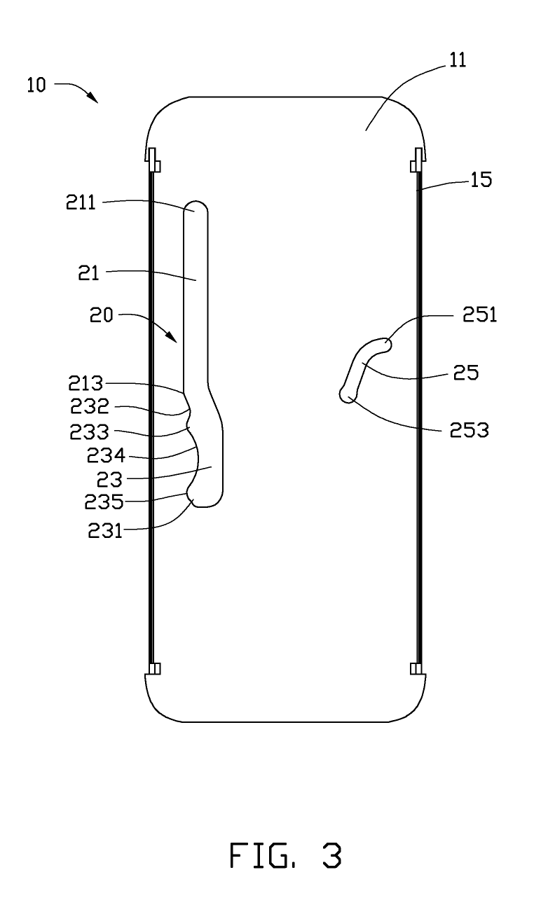

Referring to FIG. 3, the second guiding slot 20 includes a first section 21 and a second section 23. The second guiding slot 20 has a first end 211, a second end 231 and a transition point 213. The first section 21 is formed between the first end 211 and the transition point 213. The second section 22 is formed between the second end 231 and the transition point 213. The first section 21 is parallel to the rails 15. The second section 23 includes a first valley 233 adjacent to the transition point 213, a second valley 235 spaced from the first end 211 and adjacent the second end 231, a first peak 232 between the first valley 233 and the transition point 213, and a second peak 234 between the first valley 233 and the second valley 235. The first guiding slot 25 is substantially curved, and includes a first limiting end 251 and an opposite second limiting end 253.

The sliding element 30 includes an inner surface 311 facing the main body 10, an outer surface 312 opposite to the inner surface 311, two opposite sidewalls 32 protruding from the inner surface 311, and tracks 33 defined in the sidewalls 32. Each rail 15 is slidably received in one of the tracks 33 so the sliding element 30 is capable of sliding relative to the main body 10. The sliding element 30 further defines a passage 314 through the inner surface 311 and the outer surface 312, and a receiving space 315 in the outer surface 312 corresponding the passage 314. The receiving space 315 is for accommodating the second elastic device 50, and the passage 314 is for the second elastic device 50 to pass through the sliding element 30. The sliding element 30 further defines a retaining hole 313 through the inner surface 311 and the outer surface 312 for retaining the first elastic device 40 to the sliding element 30.

The first elastic device 40 includes a connecting element 41, a first sliding block 42, a second sliding block 43, a first elastic portion 46, a second elastic portion 47, a retaining pole 44 and a first guiding pole 45. The connecting element 41 includes a first retaining block 411 and a second retaining block 412 located at opposite ends thereof. The first sliding block 42 is slidably fixed to the connecting element 41 facing the first retaining block 411. The second sliding block 43 is slidably fixed to the connecting element 41 facing the second retaining block 412. The retaining pole 44 is retained to the first sliding block 42. The first guiding pole 45 is retained to the second sliding block 43. The first elastic portion 46 is retained between the first retaining block 411 and the first sliding block 42. The second elastic portion 47 is retained between the second retaining block 412 and the second sliding block 43. The first elastic portion 46 and the second elastic portion 47, in this exemplary embodiment, both may be or include coil springs. The retaining pole 44 is rotatably retained in the retaining hole 313 so the first elastic device 40 is rotatably retained to the sliding element 30. The first guiding pole 45 is slidably fixed in the first guiding slot 25 to guide the first elastic device 40 rotating relative to the sliding element 30 and the main body 10. The first guiding pole 45 has a distal end 451 larger than the first guiding slot 25 to prevent the first guiding pole 45 disengaging from the first guiding slot 25.

The second elastic device 50 includes a retaining board 51, a sliding board 511 slidably fixed to the retaining board 51, a second guiding pole 55 protruding from the sliding board 511 and a third elastic portion 53 fixed between the retaining board 51 and the sliding board 511. The retaining board 51 is retained in the receiving space 315 to retain the second elastic device 50 to the sliding element 30. The third elastic portion 53, in this exemplary embodiment, may be or include one or more coil springs. The second guiding pole 55 is slidably received in the second guiding slot 20.

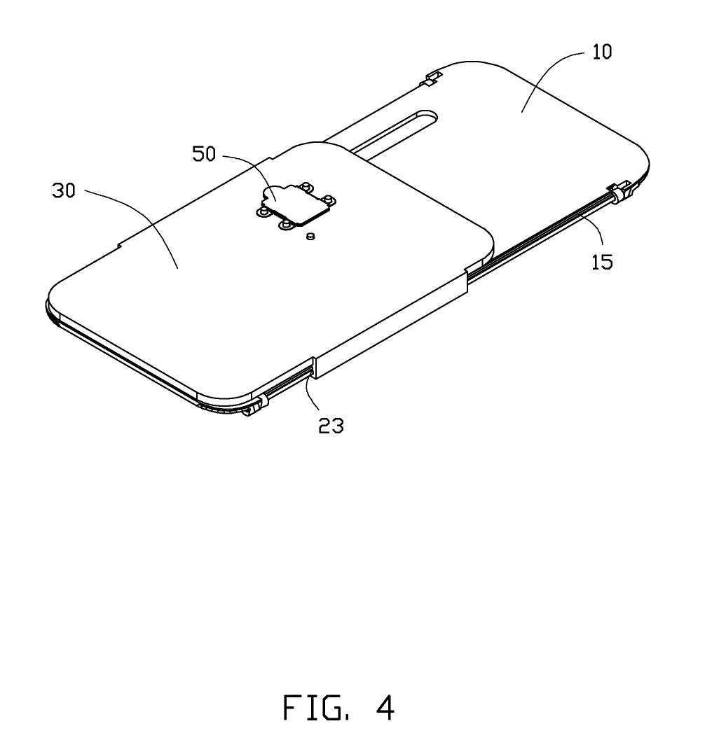

Referring to FIGS. 4 to 6, in assembly, the retaining pole 44 is retained in the retaining hole 313 so the first elastic device 40 is retained to the sliding element 30. The retaining board 51 is retained in the receiving space 315 so the second elastic device 50 is retained to the sliding element 30. The rails 15 are retained in the tracks 33 with the first guiding pole 45 located in the first limiting end 251 and the second guiding pole 55 located in the first valley 233 so the sliding element 30 is fixed to the main body 10 in the first state. At this time, the first elastic portion 46 and the second elastic portion 47 are under compression, so providing an elastic force driving the sliding element 30 to slide relative to the main body 10; the third elastic portion 53 is under compression and provides an elastic force maintaining the second guiding pole 55 tightly against the main body 10, thereby making the second guiding pole 55 stably stay in the first valley 233. In other words, the third elastic portion 53 provides an elastic force keeping the sliding element 30 positioned in the first state (of FIG. 5).

Referring to FIGS. 4 to 6, to slide the sliding element 30 relative to the main body 10 in a first direction (the direction of arrow A) from the first state (of FIG. 5) to the second state (of FIG. 6), the sliding element 30 is pushed in the first direction to make the sliding element 30 slide relative the main body 10. As the sliding element 30 slides in the first direction, the first sliding block 42 and the second sliding block 43 move towards each other to compress the first elastic portion 46 and the second elastic portion 47, until the second guiding pole 55 crosses over the first peak 232, and then the sliding element 30 automatically slides relative to the main body 10 in the first direction under the elastic force of the first elastic portion 46 and the second elastic potion, until the second guiding pole 55 has slid to the first end 211. At this time, the third elastic portion 53 is under compression and holds the second guiding pole 55 tightly against the sliding board 511, thereby keeping the second guiding pole 55 stably in the first end 211, i.e., the third elastic portion 53 provides an elastic force keeping the sliding element 30 in the second state. It is to be understood, in the second state, the first elastic portion 46 and the second elastic portion 47 may be compressed to provide an elastic force giving the sliding element 30 a tendency to slide relative to the main body 10, to keep the sliding element 30 more firmly in the second state.

Referring to FIGS. 4 and 7, to slide the sliding element 30 relative to the main body 10 in a second direction (the direction of arrow B) opposite to the first direction, from the first state (of FIG. 5) to the third state (of FIG. 7), the sliding element 30 is pushed in the second direction until the second guiding pole 55 crosses over the second peak 234, and then the sliding element 30 automatically slides further relative to the main body 10, in the second direction, under the elastic force of the second elastic portion 47, until the second guiding pole 55 slides to the second valley 235 and the first guiding pole 45s slides to the second limiting end 253. At this time, the third elastic portion 53 is under compression, providing an elastic force which presses the second guiding pole 55 tightly against the sliding board 511, thereby keeping the second guiding pole 55 stably in the second valley 235, i.e., the third elastic portion 53 provides an elastic force maintaining the sliding element 30 in the third state.

It is to be further understood that even though numerous characteristics and advantages of the exemplary embodiments have been set forth in the foregoing description, together with details of structures and functions of various embodiments, the disclosure is illustrative only, and changes may be made in detail, especially in the matters of shape, size, and arrangement of parts within the principles of the exemplary invention to the full extent indicated by the broad general meaning of the terms in which the appended claims are expressed.

What is claimed is:

1. A sliding assembly, comprising:
a main body;
a sliding element slidably mounted to the main body;
a first elastic device rotatably fixed to the sliding element, the first elastic device providing a first elastic force driving the sliding element to slide relative to the main body;
a second elastic device providing a second elastic force to lock the sliding element at different states.

2. The sliding assembly of claim 1, wherein the main body includes a set of rails, the sliding element includes a set of tracks; each rail is sliably engaged in one of the tracks so the sliding element is slidably mounted to the main body.

3. The sliding assembly of claim 1, wherein the first elastic device includes a first guiding pole, the main body defines a first guiding slot, the first guiding pole is slidalby located in the first guiding slot to guide the first elastic device rotating relative to the sliding element and the main body.

4. The sliding assembly of claim 3, wherein the first guiding slot includes a first limiting end, when the sliding element is located at a first state or a second state, the first guiding pole is located at the first limiting end.

5. The sliding assembly of claim 4, wherein the sliding element defines a retaining hole, the first elastic device includes a retaining pole rotatably fixed in the retaining hole so the first elastic device is rotatably fixed to the sliding element.

6. The sliding assembly of claim 5, wherein the first guiding slot includes a second limiting end opposite to the first limiting end, when the sliding element is located at a third state, the first guiding pole is located at the second limiting end.

7. The sliding assembly of claim 1, wherein the second elastic device includes a retaining board retained to the sliding element, a sliding board slidably fixed to the retaining board, a second guiding pole protruding from the sliding board and an elastic portion fixed between the retaining board and the sliding board; the main body defines a second guiding slot, in which the second guiding pole is slidably located.

8. The sliding assembly of claim 7, wherein the elastic portion provides an elastic force driving the second guiding pole to resist the main body to lock the sliding element at the first state, the second state and the third state.

9. The sliding assembly of claim 8, wherein the second guiding slot includes a first end, a second end and a transition point, a first section is formed between the first end and the transition point parallel to the rails, a second section is formed between the second end and the transition point; the second section includes a first valley adjacent to the transition point; when the sliding element slides relative to the main body from the first state to the second state, the second guiding pole slides from the first valley to the first end.

10. The sliding assembly of claim 9, wherein the second section further includes a second valley spaced from the first end and adjacent the second end, when the sliding element slides relative to the main body from the first state to the third state, the second guiding pole slides from the first valley to the second valley.

11. The sliding assembly of claim 1, wherein the second elastic force is perpendicular to a sliding direction of the sliding element

12. A sliding assembly, comprising:
a main body;
a sliding element being capable of sliding relative to the main body in a first direction from a closed state to a first open state, and a second direction opposite to the first direction from the first state to a second open state;
a first elastic device rotatably fixed to the sliding element, the first elastic device providing a first elastic force driving the sliding element to slide relative to the main body in the first direction and the second direction;
a second elastic device providing a second elastic force to lock the sliding element at the closed state, the first open state and the second open state.

13. The sliding assembly of claim 12, wherein the different states includes a first state, a second state, and a third state; when the sliding element slides relative to the main body from the first state to the second state, the sliding element slides in the first direction; when the sliding element slides relative to the main body from the first state to the third state, the sliding element slides in the second direction

14. The sliding assembly of claim 13, wherein the second elastic device includes a retaining board retained to the sliding element, a sliding board slidably fixed to the retaining board, a guiding pole protruding from the sliding board and an elastic portion fixed between the retaining board and the sliding board; the main body defines a guiding groove, in which the guiding pole is slidably located.

15. The sliding assembly of claim 14, wherein the elastic portion provides an elastic force driving the second guiding pole to resist the main body to lock the sliding element at the first state, the second state and the second state.

16. The sliding assembly of claim 15, wherein the second guiding slot includes a first end, a second end and a transition point, a first section is formed between the first end and the transition point parallel to the rails, a second section is formed between the second end and the transition point; the second section includes a first valley adjacent to the transition point; when the sliding element slides relative to the main body from the first state to the second state, the second guiding pole slides from the first valley to the first end.

17. The sliding assembly of claim 16, wherein the second section further includes a second valley spaced from the first end and adjacent the second end, when the sliding element slides relative to the main body from the first state to the third state, the second guiding pole slides from the first valley to the second valley.

18. The sliding assembly of claim 17, wherein the guiding groove further includes a first peak between the first valley and the transition point; when the sliding element slides in the first direction, if the guiding pole crosses over the first peak, the sliding element automatically slides relative to the main body in the first direction under the second elastic force of the first elastic device, until the guiding pole slides to the second end.

19. The sliding assembly of claim 17, wherein the guiding groove further includes a second peak between the first valley and the second valley, when the sliding element slides in the second direction, if the guiding pole crosses over the second peak, the sliding element automatically slides relative to the main body in the second direction under the second elastic force of the first elastic device, until the guiding pole slides to the second valley.

20. The sliding assembly of claim 13, wherein the second elastic force is perpendicular to the first direction and the second direction.
